(19) United States
(12) Patent Application Publication
(10) Pub. No.: US 2009/0323061 A1
(43) Pub. Date: Dec. 31, 2009

(54) Multi-color hetereodyne interferometric apparatus and method for sizing nanoparticles

(76) Inventors: Lukas Novotny, Pittsford, NY (US); Filipp Ignatovich, Rochester, NY (US)

Correspondence Address: BLANK ROME LLP, WATERGATE, 600 NEW HAMPSHIRE AVENUE, N.W., WASHINGTON, DC, 20037, US

(21) Appl. No.: 11/710,976

(22) Filed: Feb. 27, 2007

Related U.S. Application Data
(60) Provisional application No. 60/776,953, filed on Feb. 28, 2006.

(51) Int. Cl. G01N 15/02; G01B 9/02

(52) U.S. Cl. 356/336; 356/484; 977/773

(57) ABSTRACT

A nanoparticle sensor is capable of detecting and recognizing single nanoparticles in an aqueous environment. Such sensor may find applications in broad areas of science and technology, from the analysis of diesel engine emissions to the detection of biological warfare agents. Particle detection is based on interferometric detection of multi-color light, scattered by the particle. On the fundamental level, the detected signal has a weaker dependence on particle size (ÿ R³), compared to standard detection methods (ÿ R⁶). This leads to a significantly larger signal-to-noise ratio for smaller particles. By using a multi-color or white excitation light, particle dielectric properties are probed at different frequencies. This scheme samples the frequency dependence of the particle's polarizability thereby making it possible to predict the composition of the particle material. The detection scheme also employs a heterodyne or pseudoheterodyne detection configuration, which allows it to reduce or eliminate noise contribution from phase variations, which appear in any interferometric measurements.

### CROSS-REFERENCE TO RELATED APPLICATIONS

The present application claims the benefit of U.S. Provisional Patent Application No. 60/776,953, filed Feb. 28, 2006, whose disclosure is hereby incorporated by reference in its entirety into the present disclosure.

### STATEMENT OF GOVERNMENT INTEREST

The work leading to the present invention was supported by NSF Grant No. PHS-0441964. The government has certain rights in the invention.

### FIELD OF THE INVENTION

The present invention is directed to a technique for the detection of nanoparticles, such as viruses, and more particularly to an optical technique using interferometry which does not require knowledge of the dielectric properties of the nanoparticles.

### DESCRIPTION OF RELATED ART

Particle sizing is used in many areas of science and technology. The food industry, cosmetics, pharmaceuticals, paints and coatings, metals, ceramics, explosives, fireworks and semiconductor industries are just a few places that employ particle size measurements. For example, the reflectivity of road signs depend on the size of the glass beads embedded in the paint, the flavor of coffee depends on the size of the milled grains, proper size distribution of medication granules enhances absorption into the body, and particle size determines strength and performance of ceramic materials. The detection of particles is also important in areas of modern society, such as environmental protection and public health. For example, inhalation of ultra-fine particles originating from emissions of various kinds can lead to a number of adverse health effects, including inheritable genetic changes.

Currently, the advent of nanoscience and nanotechnology has made it increasingly important to reliably assess the size of nanometer scale particles. Nanoparticles find use in many areas, such as diagnostics and treatment of tumors, treatment systems for radioactive and biohazard materials, solar power energy conversion, electronic circuits, sensors, lasers, artificial bone implants and others. See, for example, Loo et al., “Nanoshell-Enabled Photonics-Based Imaging and Therapy of Cancer,” Techol. Cancer Res. T., vol. 3, no. 1, pp. 33-40, 2004.

Because of their small size, nanoparticles are not easy to detect, and it is evident that there is high demand for novel techniques for the reliable detection, characterization, sorting, and tracking of nanoscale particles of various sorts. Furthermore, as the feature size of integrated circuits becomes increasingly smaller, contamination control of ultrafine particles poses a challenge for the semiconductor industry.

A nanoparticle detector is especially important for biowarfare detection. This type of warfare is particularly devastating due to the potential for rapid infection from a small amount of biological agents. One need only look at the disruption to the U.S. federal government caused by the mailing of anthrax spores, or to the economic harm caused in many countries due to the outbreak of severe acute respiratory syndrome (SARS), to realize the magnitude of such a threat. Warfare viruses are especially dangerous because no cures exist against many viruses. An early detection is one of the few defenses against such threats. A broad network of sensors, cheap and robust enough to be placed throughout public spaces with credible threats of attack, can provide a reliable early warning of an attack.

The field of particle sizing science is very broad. A database of American Society for Testing and Materials contains over 140 particle sizing methods which have evolved over the past number of years. These methods can be classified into sieving, image analysis, fluid classification, and interaction between particles and external fields. Sieving has been used for thousands of years and is still widely used in industry to sort particles based solely on their sizes. Particles are analyzed by essentially sifting the sample powder through a stack of sieves. Image analysis methods measure particle dimensions from images acquired with optical and electron microscopes. Fluid classification methods include gravitational and centrifugal sedimentation methods, which are based on the settling behavior of particles in a suspension under gravitational or centripetal force. Finally, there are techniques based on interaction between particles and external fields include interactions with electrostatic fields, electromagnetic (optical) and acoustic waves. Most of the developed particle measurement systems are designed to measure micrometer or above diameter particles.

Some optical methods are, however, capable of detecting sub-micron particles. Optical methods for particle detection rely on light scattering. See, for example, L. Fabiny, “Optical Particle Counters,” Opt. Phot. News, vol. 9, pp. 34-38, 1998. In the simplest version, an optical particle counter (OPC) includes a light source, usually a laser, which illuminates a sample volume containing particles of interest. The particles scatter light, which is collected by an off-axis detector. The angular distribution of the scattered light intensity is a function of a number of parameters such as particle size, shape, optical density and concentration. These parameters can be extracted from the measured data by solving the inverse Mie scattering problem. Beyond the basic design, there are many variations of OPCs, some of which count individual particles and others measure ensemble average. Examples of single particle counters are a Flow Cytometer, a Phase Doppler Anemometer (PDA) and some versions of Condensation Nuclei Counters (CNC). Examples of OPCs which measure ensemble average are Dynamic Light Scattering (DLS) sensors, Nephelometers (or multiangle photometer) and other versions of the CNCs.

The configuration of a typical optical particle counter is illustrated in FIG. 1. A collimated or focused light from a laser illuminates a sample volume of an aerosol or other aqueous sample. An off-axis detector collects the scattered light and makes a detection determination within a determined time, according to the specifics of the system.

Most optical particle counting systems are only sensitive to particles above 200 nm. There are only two optical methods capable of measuring nanoparticles below 100 nm in size: the CNC and the DLS sensors. In the CNC method, saturated vapors of water or alcohol are used to grow bubbles around nanoparticles. This way, particles grow in size and become accessible by other optical detection techniques. It is, however, very difficult to grow bubbles in a controlled manner, thus the original particle size information is often unavailable. The DLS method measures the Brownian motion dynamics of particles by monitoring the time fluctuations of a total number of particles within a small volume. Smaller particles enter or leave the monitored volume more often than the larger particles. Therefore, the time autocorrelation of the measured signal contains information about particle size. The DLS method is capable of measuring particle sizes down to 2-3 nanometers in size, is independent of the optical properties of the particles and is very effective in analyzing monodisperse samples. However, the precision of the DLS size measurements decreases with the polydispersity of particle sizes in a sample. Also, since the DLS sensors measure ensemble averages, they require high particle concentrations. For example, state of the art systems can measure concentrations down to 0.1 mg/ml, which correspond to 2×10¹³ particles/ml for 20 nm polystyrene beads. The cost and complexity of measurements grow quickly as particle size approaches a few tens of nanometers.

There are, however, only a few projects that are aimed at developing OPCs with single particle sensitivity below 100 nm. One such group was able to optimize the standard OPC configuration to detect polystyrene particles down to 90 nm in diameter by minimized light scattered by the media and optical elements which contribute to noise level. See, M. Hercher et al., “Detection and Discrimination of Individual Viruses by Flow Cytometry,” vol. 27, pp. 350-352, 1979. However, the complexity of their setup precludes practical applications of the system in scientific laboratories, as well as in commercial production. Additionally, 74 nm diameter polystyrene spheres have been detected using essentially an inverse dark-field configuration. See, H. Steen, “Flow Cytometer for Measurement of the Light Scattering of Viral and Other Submicroscopic Particles,” vol. 57A, pp. 94-99, 2004. The incident beam in this setup is blocked by placing a field stop in the center of the exit pupil of a collection objective, while light scattered at higher angles was collected.

In both of the above-discussed projects, as well as in other optical detection methods, a very strong dependence of the detected signal on particle size is a main obstacle in detecting nanoparticles. The scattering cross-section for a particle much smaller than the wavelength of excitation source is:

$${C}_{scatter} = \frac{8 π}{3} {( \frac{2 π}{λ} )}^{2} {R}^{6} {\vert {ɛ}_{m} \frac{{ɛ}_{p} - {ɛ}_{m}}{{ɛ}_{p} + 2 {ɛ}_{m}} \vert}^{2} \qquad ( 1 )$$

where R is the particle radius, ∈ₚ and ∈ₘ are the dielectric permittivities of the sphere and the surrounding medium, respectively, and λ is the wavelength of the light. Therefore, the signal to noise ratio decreases very rapidly with particle size. In order to lower the detectable particle size in currently available instruments from 200 nm to 20 nm, the noise level would have to be reduced by six orders of magnitude, which is not realistic.

In addition to size of the particles, it is often necessary to know the particle composition. It is relatively easy to analyze bulk materials, whether by looking at their optical (light absorption, fluorescence), physical (stiffness, elasticity) or chemical (solubility, reactivity) properties or atomic composition (percentage amount of carbon, nitrogen or other atoms). Therefore, it is also possible to identify materials in a highly concentrated particle sample. That can be done, for example, by acquiring absorption spectra in a spectrophotometer, or by collecting fluorescence or Raman scattering spectra. These methods, however, are not suitable for single particle identification. Physical properties cannot be accessed on the nanoscale level, chemical reactions cannot be monitored using such small volumes of reagents. Raman scattering and fluorescence cross-sections are very small and do not enable enough information to be collected from single nanoparticles. Only recently have near-field methods been developed that are capable of detecting absorption, luminescence and Raman scattering from a single nanoparticle immobilized on a surface. In principle, X-ray microanalysis can be used to obtain atomic structure of materials, but such method requires expensive equipment, cumbersome sample preparation and lacks high throughput.

Although these methods extend the detection sensitivity to smaller particle sizes, they suffer from other shortcomings which prevent the detection of single nanoparticles in real time. Either they require particle immobilization to ensure sufficiently long acquisition times or they are subject to a background signal originating from Brownian motion or direct detector exposure. Therefore, a new detection scheme is needed for the recognition of viruses and other nanoparticles. Such a scheme needs to provide accurate, simple and affordable ways of detecting small nanoparticles and biological agents. Such detection devices also need to be capable of obtaining chemical signatures and identifying particles with high specificity.

### SUMMARY OF THE INVENTION

It is therefore an object of the invention to provide a technique for measuring nanoparticles which overcomes the above-noted shortcomings.

To achieve the above and other objects, the present invention is directed to a background-free detection approach which gives unsurpassed real-time detection sensitivity for nanoscale particles. The successful detection and classification of low-index particles has been demonstrated. The detection scheme is well suited for the screening and sorting of various nanoscale particles such as viruses and other bodies and is compatible with current microfluidic technology.

According to at least one embodiment, the invention is directed to a method for detecting a particle in a location. The method includes emitting electromagnetic radiation, splitting the electromagnetic radiation into a first component and a second component, directing the first component into a reference arm and directing the second component into the location. The method further includes receiving light backscattered from the location, causing the backscattered light to interfere with the first component from the reference arm to produce an interference intensity distribution using at least two wavelengths, detecting the interference intensity distribution with a detector at the at least two wavelengths and detecting the particle in accordance with a difference among detection signals.

In addition, the light may come from a white light source and a plurality of paired photodetectors. The interference pattern may also differentiate different wavelengths of light into different angles using an optical grating. Also, the light may come from multiple lasers and be detected through multiple split detectors. The number of lasers of the multiple lasers and the number of split detectors of the multiple split detectors may be equal. The method may also include oscillating a position of a mirror in the reference arm to modulate the phase of the first component. A frequency dependence of the particle's polarizability may be sampled and a composition of the particle may be predicted.

According to at least another embodiment, a system for detecting a particle in a location includes a source of electromagnetic radiation, a beam splitter for splitting the electromagnetic radiation into a first component and a second component and a reference arm receiving the first component from the beam splitter. The system also includes focusing optics, receiving the second component from the beam splitter, for directing the second component into the location and for receiving light backscattered from the location, thereby causing the backscattered light to interfere with the first component from the reference arm to produce an interference intensity distribution, a detector comprising a plurality of components for detecting the interference intensity distribution at the at least two wavelengths and a data acquisition system for detecting the particle determining the particle's absolute size in accordance with a difference among detection signals from the plurality of components.

### BRIEF DESCRIPTION OF THE DRAWINGS

A preferred embodiment of the present invention will be set forth in detail with reference to the drawings, in which:

FIG. 1 shows a schematic rendering of the detector used in prior art particle detection;

FIG. 2 shows a schematic rendering of the detector according to a preferred embodiment of the present invention;

FIG. 3 shows a schematic rendering of the detector according to another preferred embodiment of the present invention;

FIG. 4 shows a graph of a differential signal from a split photodetector corresponding to 50 nm radius polystyrene beads passing through the laser focus;

FIG. 5 shows a schematic rendering of the detector according to another preferred embodiment of the present invention, using an acousto-optic modulator (AOM);

FIG. 6(a) shows a typical photo-detector signal, FIG. 6(b) shows a split photodetector signal and FIG. 6(c) shows the extracted amplitude cure of the signal in FIG. 6(a);

FIG. 7 shows a schematic rendering of the detector according to another preferred embodiment of the present invention, using multiple AOMs;

FIG. 8 shows a schematic rendering of the detector according to another preferred embodiment of the present invention, using a single split detector for multiple wavelengths; and

FIG. 9 shows a schematic rendering of the detector according to another preferred embodiment of the present invention, using a single AOM and a single laser source.

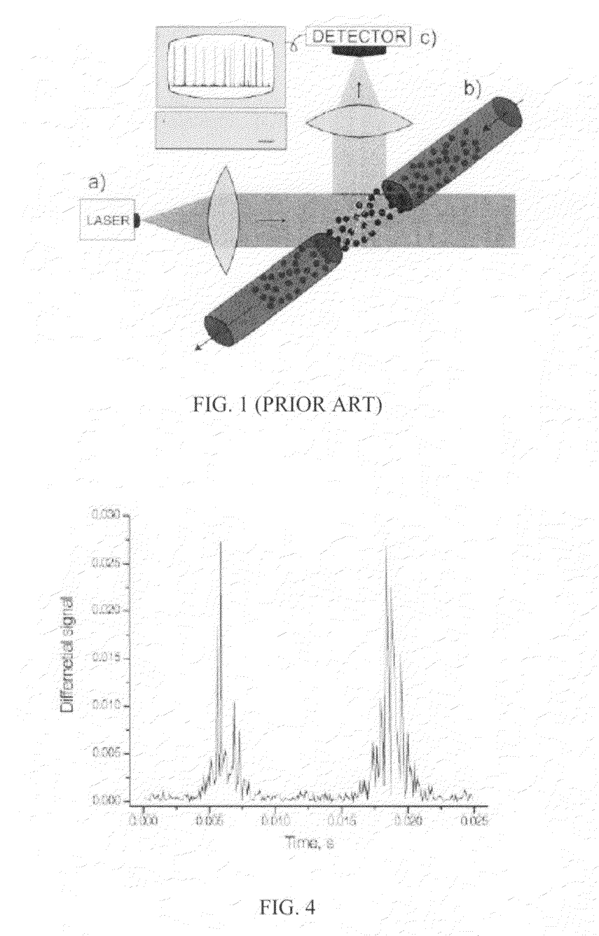

### DETAILED DESCRIPTION OF THE INVENTION

The present invention will be set forth in detail with reference to the drawings, in which like reference numerals refer to like elements or operational steps throughout.

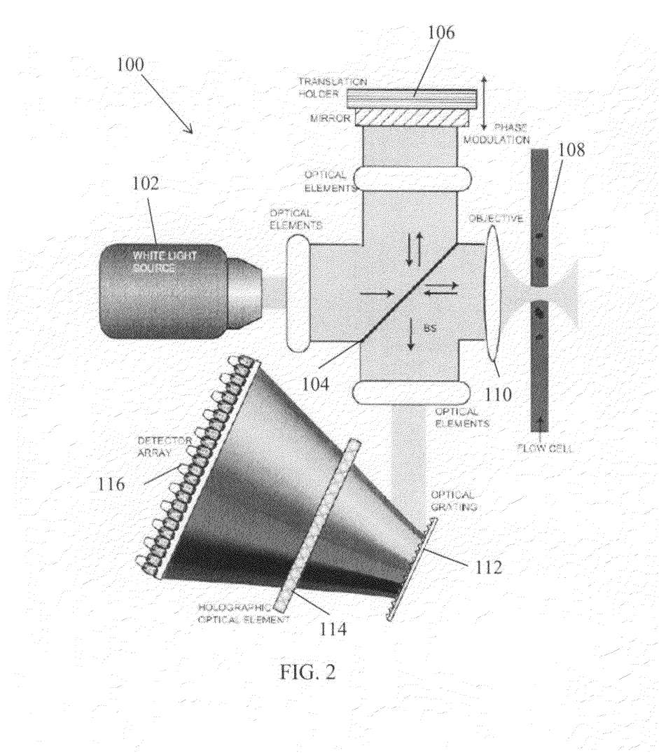

FIG. 2 illustrates a schematic of a particle detector 100, according to at least one embodiment of the present invention. The excitation light from a light source 102 is split into two parts by a nonpolarizing beamsplitter 104. One part of the beam is reflected back by an oscillating mirror 106, creating a reference beam arm. The other part is focused inside a microfluidic channel 108, containing the particles of interest. The dimensions of the microfluidic channel 108 are comparable to the size of the focus. In one embodiment, the intensity distribution of the focused light across the focus is uniform, so that particles crossing the focus at different parts of the nanochannel are subject to equal illumination conditions.

Particles are moving through the focus via liquid flow. As a particle travels through the focus, the incident light is scattered back. The scattered light is collected by the focusing objective 110 and is recombined with the reference beam using the same beamsplitter. Both the reference beam and the scattered light are then incident on the optical grating 112, which separates light of different wavelengths into different angles. Such angular light arrangement is then collimated by a computer-controlled holographic optical element 114 and is collected by an array of paired detectors 116. For each wavelength, scattered light and light from the reference arm create an interferometric pattern on the corresponding pair of detectors. The time-varying signal from the detectors is collected by a computer using a high-speed data acquisition card. The size and the spectral signature of the particles are extracted by analyzing the acquired signal. The detector signal is about one millisecond long, which is about the time it takes for a single particle to cross the focus of the focusing objective 110.

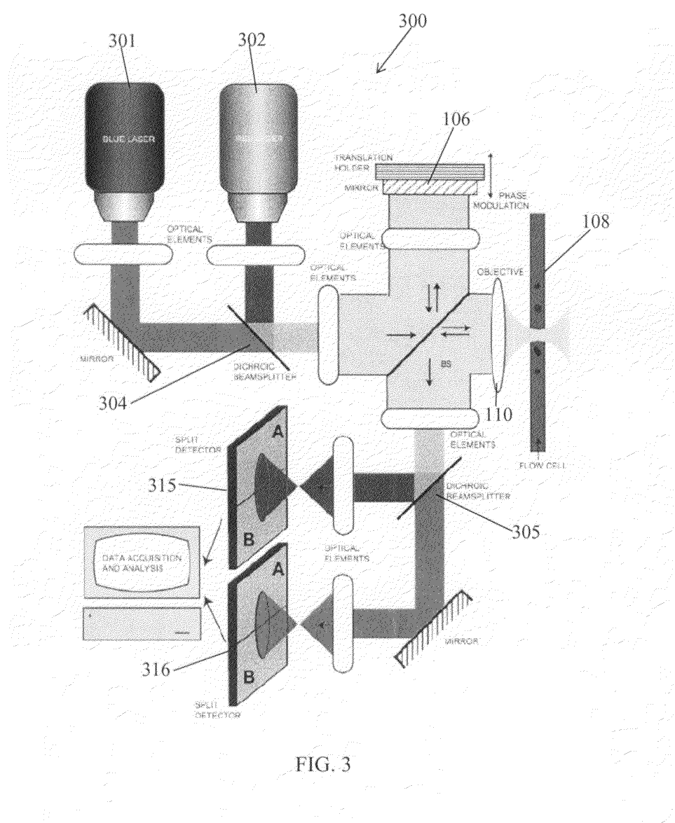

Parts of the setup can be varied depending on the performance requirements and costs. For example, two or more single-frequency lasers 301 & 302 can be used instead of a white light source. Such an embodiment 300 is illustrated in FIG. 3. The separate lasers can generate more light intensity per wavelength, thus increasing sensor sensitivity to smaller particles. This does, however, reduce the ability to specify the material composition. Additional optical elements can be used to reshape the incident beam to have a uniform intensity distribution in the focus, leading to increased detection resolution. It should be noted that while the embodiment illustrated in FIG. 3 includes two single-frequency lasers, embodiments can also be constructed that include just one laser and still maintain the heterodyne nature of the instant invention. The optical grating and the detector array, illustrated in FIG. 2, in this embodiment, can be replaced by two or more dichronic beamsplitters 304 & 305 and two or more split photodetectors 315 & 316, thus dramatically reducing overall costs. This detector configuration will be used to explain the technology behind the present invention in the following sections.

The present invention operates under three main principles of operation to achieve high sensitivity and specificity in particle detection. First, by interfering the scattered light and the incident beam on a split photodetector, or on a single pair of detectors within an array of detectors, the scattered light amplitude is measured. The scattered light amplitude is proportional to the third power of the particle size, i.e. R³. Currently marketed particle sensors detect scattered light power, which is proportional to R⁶. The weaker particle size dependence leads to a higher signal-to-noise ratio for smaller particles, compared to R⁶ methods.

Second, the pseudoheterodyne detection approach removes noise associated with phase variations. Interferometric measurements are usually very sensitive to phase differences between two interface beams. For example, air currents can change the effective path length in the arms of an interferometer, thus leading to phase changes. Small vibrations in optical elements can also lead to large phase variations. In the present invention, the largest measurement error comes from the phase variations within the light focus. Even in small nanochannels, the phase of the light scattered by the particles varies rapidly depending on a particle's trajectory. Such noise leads to errors in particle size measurements and limits resolving power of the sensor. The use of the oscillating mirror in the reference arm and a smart detection algorithm helps eliminate phase error contributions to the measured signals.

Third, multiple frequency light is used to probe the particle scattering efficiency (or particle polarizability) at different frequencies. This information is unique for each material and can be used to identify particle composition. The inelastic scattering cross-section is much higher compared to common inelastic scattering techniques of fluorescence and Raman scattering. Thus, this leads to a higher signal-to-noise ratio for small particles and the ability to measure the spectral properties of single particles within the millisecond time frame. To measure spectral properties, interferometric data for each wavelength is collected independently. The sensor embodiment in FIG. 2 uses an optical grating and optical holographic elements to separate white light into different wavelengths and the sensor embodiment in FIG. 3 uses dichronic beamsplitters to separate data from two lasers.

A nanoparticle placed in a laser field acts as a dipole with the induced dipole moment:

$$p = 2 π {ɛ}_{m} {R}^{3} \frac{{ɛ}_{p} - {ɛ}_{m}}{{ɛ}_{p} + 2 {ɛ}_{m}} {E}_{0} \qquad ( 2 )$$

where E0 is the excitation electric field. The electric field scattered by a nanoparticle is proportional to the induced dipole moment and is therefore proportional to the third power of particle size. A typical photodetector cannot be used to directly measure scattered field amplitude, because it measures power or amplitude squared of the incident light. However, if the scattered and excitation light are interfered on a split photodetector, the difference in signal from one half and the opposite half of the detector (A-B) is proportional to the scattered amplitude.

A split photodetector can be formed from a PIN photodiode with a circularly shaped detection area, which is divided into two equal parts by small (10-30 mm) insulator gaps. Each half is independent from the other and has its own output. A quadrant detector, which has four independent parts instead of two, may be used, where the quadrant detector is also called a position sensing detector (PSD). A quadrant detector can be converted into a split photodetector by connecting adjacent quadrants.

Denoting E and Eₛ as the reference and scattered light fields, respectively, on the split photodetector, the two fields create an interference pattern. The intensity distribution of such a pattern is:

I(x,y)=|E+Eₛ|²=|E|²+2Re(E·Eₛ)+|Eₛ|² (3)

Typically, the scatter field intensity is much smaller than the laser intensity and thus |Eₛ|² can be neglected compared to the other terms in eq. (3), thus:

I(x,y)=|E|²+2Re(E·Eₛ) (4)

The differential detector signal, S=A-B, is obtained by integrating the intensity distribution over the corresponding halves of the split detector:

$$S = {\int }_{⋐} I d a - {\int }_{⊃} I d a \qquad ( 5 )$$

where α denotes the integration area, ⊂ and ⊃ denote the two halves of the photodetector surface and ∘ denotes the entire photodetector surface. In the absence of a passing particle, the reference beam and the light backreflected by optical elements are adjusted into the center of the split photodetector such that the differential signal S is zero. The interference between the reference beam and the backreflected light does not affect the detection method because it is stationary and therefore does not generate any differential signal. Thus, S is a background-free signal similar to fluorescence that is commonly used to detect and track single molecules.

Using equations (4) and (5):

$$S = {\int }_{⋐} {\vert E \vert}^{2} d a - {\int }_{⊃} {\vert E \vert}^{2} d a + 2 {\int }_{⋐} Re ( E \cdot {E}_{s} ) d a - 2 {\int }_{⋐} Re ( E \cdot {E}_{s} ) d a . \qquad ( 6 )$$

Assuming that the reference beam spot is positioned at the center of the photodetector, the intensity distribution is due to |E|² being symmetric with respect to the insulating gap on the detector and thus the first two terms of eq. (6) cancel each other and:

$$S = 2 Re [ {\int }_{⋐} E \cdot {E}_{s} d a - {\int }_{⊃} E \cdot {E}_{s} d a ] ∝ {EE}_{s} \qquad ( 7 )$$

It can be seen that the differential signal in eq. (7) is proportional to the scattered field and therefore depends on the third power of the particle size. In order to make the signal insensitive to the noise in the laser power, it can be normalized to the total power incident on the detector:

$$P = {\int }_{O} I d a \approx {\int }_{O} {\vert E \vert}^{2} d a \qquad ( 8 )$$

The normalized differential signal is then proportional to the ratio between the scattered field strength and the laser field strength:

$$s ∝ \frac{S}{{E}^{2}} = \frac{{E}_{s}}{E} \qquad ( 9 )$$

The scattered field, Eₛ, is proportional to the particle's dipole moment, p, and therefore to the electric field in the microscope objective focus, E₀, therefore:

$$s ∝ α \frac{{E}_{0}}{E} \qquad ( 10 )$$

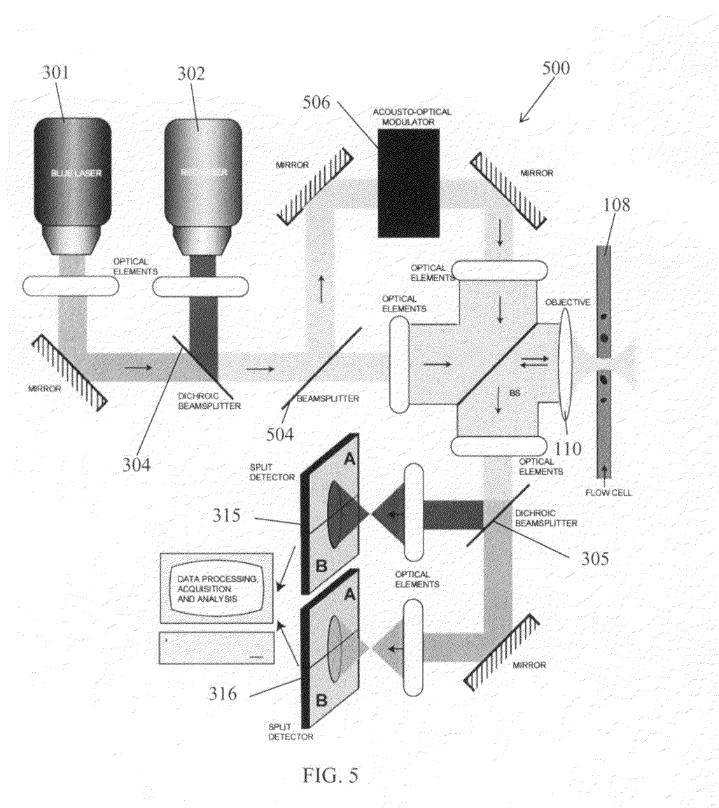

As a particle passes through the focus, the amount of scattered light varies depending on where the particle is located with respect to the center of the focus, resulting in a non-zero time-dependent photodetector signal. The amplitude of the signal is constant for particles of the same size, given the maximum illumination conditions are the same within the nanochannel. FIG. 4 shows examples of time-dependent signals from the photodetector for 50 nm radius polystyrene beads moving through the laser focus. The signal amplitude is different for different size particles.

The signal-to-noise ratio (SNR) found from the use of the present invention should be compared with that of the standard scattering-based detection. Ultimately, the highest SNR can be achieved when the background light acts as a reference beam. The absolute maximum of the interferometric amplitude in this case is achieved when the interference patterns concentrate all of the energy on one half of the split photodetector (s=1). That can only happen if the scattered field amplitude is equal to the amplitude of the background light E_{b}, i.e. |Eₛ|=|E_{b}|. For sufficiently strong powers, the SNR becomes {S/N}=(1/θ) Eₛ/E_{b}, where t is the angular pointing instability of the light source beam. On the other hand, the maximum SNR in standard light scattering can be written as {S/N}=(1/η)Eₛ²/E_{b}², where η is the laser power noise.

First, the SNR in the present invention is proportional to Eₛ²/E_{b}², versus Eₛ²/E_{b}² for scattering-based detection, and therefore proportional to the third power of the particle size, versus the sixth power of the particle size for scattering-based approaches. Second, the SNR in standard light scattering methods depends on laser power noise, which cannot be easily controlled. On the other hand, the present invention does depend on the angular pointing stability of the laser which can be controlled, for example, by reducing the optical path length. Furthermore, the dimensionless pointing instability coefficient θ for the laser is much smaller (by orders of magnitude) than typical noise power.

With respect to pseudoheterodyne detection, if E=E exp(iω₀t+φ) and Eₛ=Eₛ exp(iω₀t+φₛ), the differential signal in eq. (7) becomes:

S∝EEₛ cos(φ−φₛ) (11)

where ω₀ is the optical frequency, and φ and φₛ are phases of the scattered and reference beams. It is immediately clear that the signal S not only depends on the amount of scattered light Eₛ, but also on the phase φₛ. Because of the harmonic behavior, the signal S can change with the full dynamic range of −EEₛ to +EEₛ. Small variations in phase can result in large measurement errors in the amplitude and therefore in size. Pseudoheterodyne detection allows for the separate measurement of EEₛ and cos(φ−φₛ).

The basic idea behind pseudoheterodyne detection is to modulate the phase of one of the beams with high frequency. This modulation is implemented by oscillating the position of the reference beam mirror, as shown in FIGS. 2 and 3. In this case, the electric field of the reference beam is given by:

E=Eexp[iφ₀t+ik₀x₀ sin(ωₘt)+iφₛ] (12)

where ωₘ is the modulation frequency, x is the modulation amplitude and k0x is the phase amplitude due to modulation. The measured differential signal is then:

S∝EEₛ cos(k₀x₀ sin(ωₘt)+φₛ−φ) (13)

=EEₛ[cos(k₀x₀ sin(φₘt))cos(φ−φₛ)−sin(k₀x₀ sin(ωₘt))sin(φ−φₛ)] (14)

Using the mathematical expression:

$${e}^{i θ co s ( {ω}_{m} t )} = {J}_{0} ( θ ) + 2 {\sum }_{n} {i}^{n} {J}_{n} ( θ ) cos ( n {ω}_{m} t ) \qquad ( 15 )$$

the signal S can be expanded into multiple harmonics, oscillating at frequencies nωₘ. The amplitude of each harmonic can be extracted using a lock-in amplifier. Therefore, the amplitude of the first harmonic is:

S(1ωₘ)=EEₛ[J₁(k₀x₀)sin(φ−φₛ)] (16)

and the second harmonic is:

S(2ωₘ)=EEₛ[J₂(k₀x₀)cos(φ−φₛ)] (17)

Assuming that x₀ can be adjusted to satisfy the relationship J₁(k₀x₀)=J₂(k₀x₀), then the first and second harmonics can be squared and added to together, giving:

S_{heterodyne}=\sqrt{S²(1ωₘ)+S²(2ωₘ)}=EEₛJ₁(k₀x₀) (18)

It can be seen that the last expression does not contain any phase terms. By measuring heterodyne amplitude, the phase dependence is eliminated and errors associated with phase variations within the focus can also be eliminated. The resolving power, or how close can particles be in size to be separately recognized, is therefore improved.

With respect to multi-color detection, when white light or multiple lasers are used to illuminate particles in the focus, the induced dipole moment should be rewritten as:

$$p ( ω ) = 4 π {ɛ}_{m} {R}^{3} \frac{{ɛ}_{p} ( ω ) - {ɛ}_{m}}{{ɛ}_{p} ( ω ) + 2 {ɛ}_{m}} {E}_{0} ( ω ) \qquad ( 19 )$$

where ∈ₚ(ω) describe dielectric properties of a particle at different light frequencies Co. The shape of ∈ₚ(ω) uniquely identifies the composition material of the particle. When many excitation wavelengths (colors) are used in the present invention, ∈ₚ(ω) is probed at those wavelengths. The sensor illustrated in FIG. 3 uses two wavelengths to measure particle dielectric properties at two different wavelengths. In the case of the sensor illustrated in FIG. 2, the number of identifying points in the ∈ₚ(ω) curve is limited by the number of paired detectors in the detector array.

At each wavelength at which the pseudoheterodyne interferometric amplitude is measured, information can be derived about particle size R and dielectric properties ∈ₚ(ω). The more wavelengths that are probed, the more precise a measure of the particle's size and material can be extracted.

FIG. 5 shows an alternative configuration of the particle sensor 500, according to the present invention. This configuration employs an acousto-optic modulator (AOM) 506 instead of an oscillating mirror. An acousto-optic modulator shifts the frequency of the incident light by the modulation frequency. The frequency shift is given by the modulation frequency of the AOM, ωₘ. Two or more AOM's in series can be used to obtain the desired frequency shift. The combined light from two lasers 301 & 302 is divided into two beams by a beam splitter 504. The first beam is directed through an AOM. The output of the AOM forms a reference beam. The second beam is focused inside a microfluidic cell 108 with particles of interest. The light scattered by a moving particle, and the reference beam are combined using a second beam splitter. The light of each color is then extracted using a dichroic beam splitter 305 and is directed onto the corresponding split photodetectors 315 & 316.

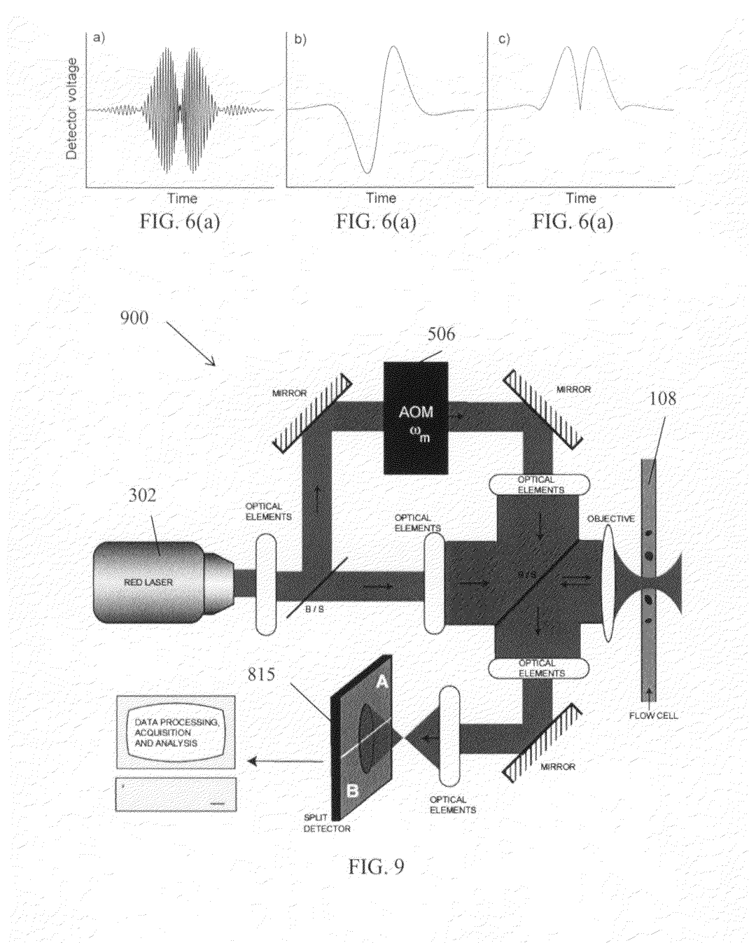

The interference between the scattered light and the frequency-shifted reference light gives rise to a split detector signal oscillations with frequency ωₘ. The amplitude of the oscillations is modulated depending on the amount of light scattered by the particle. FIG. 6(a) shows a typical photo-detector signal that corresponds to a particle crossing the center of the focus. In comparison, FIG. 6(b) contains a split photodetector signal if the AOM is absent in the reference beam path. The modulated signal is then electronically processed using the lock-in technique to extract the amplitude and phase information of the scattered light. FIG. 6(c) shows the extracted amplitude curve that corresponds to the detector signal in FIG. 6(a).

Similar to the other embodiments, the end result is the phase-insensitive signal, where the maximum amplitude is directly proportional to the third power of particle size and to particle's optical properties at the wavelength of the probing light. Similar to the other preferred embodiments, the split photodetectos renders zero (background-free) signal when particle is absent in the focus, i.e. the interferences between the reference beam and the background reflections from the optical elements or fluidic interfaces do not result in oscillations at the output of the split photodetector (when the photodetector is properly aligned). Similar to the other embodiments, the detection bandwidth is shifted to a higher frequency where less noise is present.

When compared with the other embodiments, the embodiment illustrated in FIG. 5 is different, in that only first harmonic of ωₘ is present in the split photodetector signal. Additionally, the first harmonic is sufficient to extract the amplitude and the phase information from the signal. Different from the other embodiments, the heterodyne signal is generated due to the frequency shift in the reference beam using AOM(s), instead of the harmonic phase modulation using an oscillating mirror.

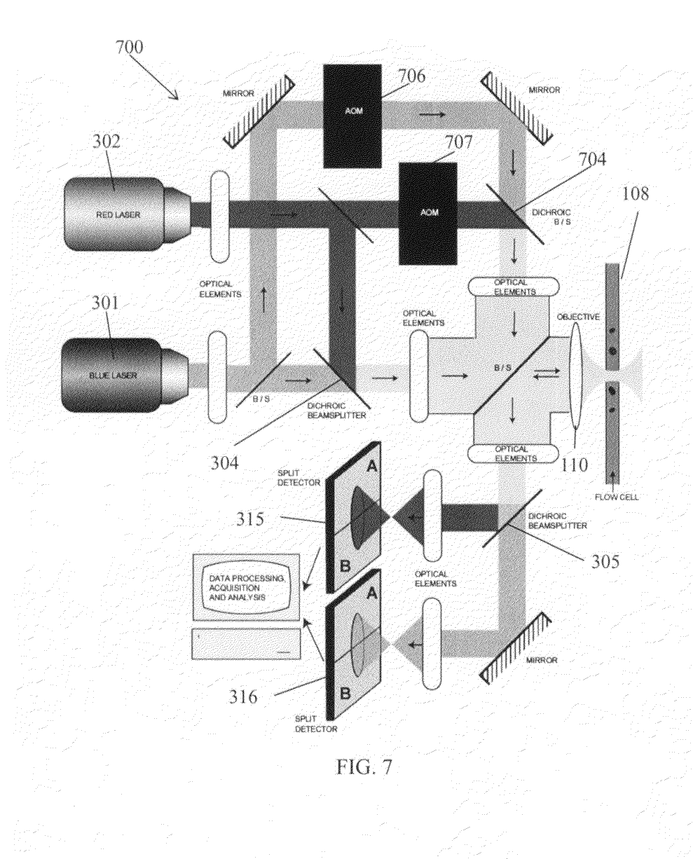

An alternate embodiment is also provided in FIG. 7, with a detector 700 that uses two AOMs. The light from each laser 301 & 302 is divided into two beams by two beam splitters. The first two beams are combined by a dichroic beam splitter 304 and the resulting light is focused inside a microfluidic cell 108 with particles of interest, similar to the embodiments in FIGS. 2 and 3. The other two beams are transmitted through acousto-optic modulators (one or several for each beam) 706 & 707. The outputs of the AOMs are re-combined using a dichroic beam splitter 704 and form the reference arm of the interferometer. The light scattered by the moving particle forms the test arm of the interferometer. The reference and the test beams are re-combined by a second beamsplitter. The light of each color is then extracted by a dichroic beam splitter 305, and is incident on the corresponding split photodetectors 315 & 316.

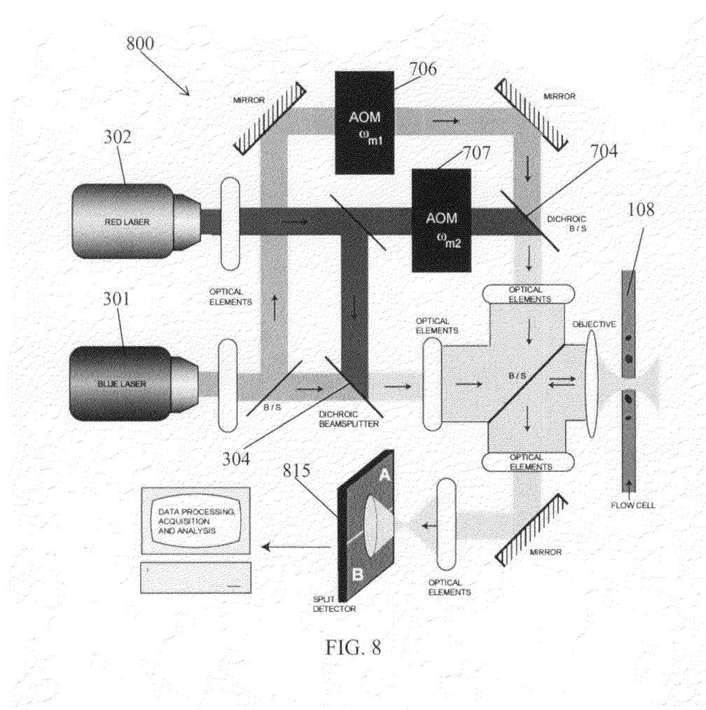

FIG. 8 shows embodiment that is similar to FIG. 7, except that the detector 800 has only one split detector 815 is used to measure the heterodyne signal for both laser wavelengths. The two AOM's 706 7 707 shift the frequencies of the reference light by different amount, ωₘ₁ for the first laser and ωₘ₂ for the second laser. The output of the split detector therefore is a sum of two heterodyne signals at two different modulation frequencies, ωₘ₁ and ωₘ₂. Using a lock-in technique, the data at ωₘ₁ can be easily separated from ωₘ₂. It means, that the optical information about particles at the two different wavelengths is accessed without the use of an additional split detector.

Such an approach can be extended to three or more lasers (or to a white light source) used with three or more AOM's operating at different modulation frequencies, and a single split detector. Illustrative of that is FIG. 9, showing a detector 900, which is basically FIG. 8 with just one laser source. In that latter embodiment, the AOM acts to shift the light source to achieve the needed effect to the detection and characterization of the present invention.

The present invention establishes new strategies in ultrasensitive particle and virus detection, and will provide new tools relevant to nanoscience and nanotechnology. In addition to detection of agents used in biowarfare and terrorism, the present invention also has applications ranging from contamination control of water, ultrasensitive flow cytometry and environmental monitoring of pollutants.

While a preferred embodiment of the invention has been set forth above, those skilled in the art who have reviewed the present disclosure will readily appreciate that other embodiments can be realized within the scope of the invention. For example, numerical values are illustrative rather than limiting, as are specific techniques for attenuation and the like. Therefore, the present invention should be construed as limited only by the appended claims.

What is claimed is:

1. A method for detecting a particle in a location, the method comprising:
emitting electromagnetic radiation;
splitting the electromagnetic radiation into a first component and a second component;
directing the first component into a reference arm;
directing the second component into the location;
receiving light backscattered from the location;
causing the backscattered light to interfere with the first component from the reference arm to produce an interference intensity distribution using at least two wavelengths;
detecting the interference intensity distribution with a detector at the at least two wavelengths; and
detecting the particle in accordance with a difference among detection signals at the at least two wavelengths.

2. The method of claim 1, wherein the step of detecting the particle further comprising determining an absolute size of the particle.

3. The method of claim 1, wherein the emitting step comprises emitting multiple wavelengths of light from a white light source and the step of detecting the interference intensity distribution comprises detecting the interference intensity distribution through a plurality of paired photodetectors.

4. The method of claim 3, wherein the step of detecting the interference intensity distribution further comprises separating different wavelengths of light into different angles using an optical grating.

5. The method of claim 1, wherein the emitting step comprises emitting multiple wavelengths of light from multiple lasers and the step of detecting the interference intensity distribution comprises detecting the interference intensity distribution through multiple split detectors.

6. The method of claim 5, wherein a number of lasers of the multiple lasers and a number of split detectors of the multiple split detectors are equal.

7. The method of claim 1, further comprising oscillating a position of a mirror in the reference arm to modulate the phase of the first component.

8. The method of claim 1, further comprising modulating a phase one of the first component and the second component through at least one acoustic-optic modulator.

9. The method of claim 1, further comprising sampling a frequency dependence of the particle's polarizability and predicting a composition of the particle.

10. A system for detecting a particle in a location, the system comprising:
a source of electromagnetic radiation;
a beam splitter for splitting the electromagnetic radiation into a first component and a second component;
a reference arm receiving the first component from the beam splitter;
focusing optics, receiving the second component from the beam splitter, for directing the second component into the location and for receiving light backscattered from the location, thereby causing the backscattered light to interfere with the first component from the reference arm to produce an interference intensity distribution using at least two wavelengths;
a detector comprising a plurality of components for detecting the interference intensity distribution at the at least two wavelengths; and
a data acquisition system for detecting the particle in accordance with a difference among detection signals from the plurality of components at the at least two wavelengths.

11. The system of claim 10, wherein the data acquisition system derives an absolute size of the particle.

12. The system of claim 10, wherein the data acquisition system derives a particle detection signal from a difference between the detection signals from two of said components.

13. The system of claim 10, wherein one of the reference arm and the focusing optics further comprises at least one phase modulator for changing a phase of one of the first component and the second component.

14. The system of claim 13, wherein the phase modulator comprises a translation holder mounted to a mirror within the reference arm.

15. The system of claim 13, wherein the phase modulator comprises at least one acousto-optic modulator.

16. The system of claim 10, wherein the source of electromagnetic radiation comprises a white light source.

17. The system of claim 10, wherein the source of electromagnetic radiation comprises at least two lasers, operating at different frequencies.

18. The system of claim 10, wherein the plurality of components of the detector comprises at least two split detectors.

19. The system of claim 10, wherein the plurality of components of the detector comprises an optical grating and an array of paired detectors.

20. The system of claim 18, wherein the plurality of components of the detector further comprises holographic optical element to collimate light separated by the optical grating.

21. The system of claim 10, wherein the beam splitter comprises multiple dichronic beam splitters.

22. The system of claim 10, wherein the data acquisition system is configured to sample a frequency dependence of the particle's polarizability and predict a composition of the particle.
